(19) United States
(12) Patent Application Publication
(10) Pub. No.: US 2005/0081051 A1
(43) Pub. Date: Apr. 14, 2005

(54) Mitigating self-propagating e-mail viruses

(75) Inventors: Janice Marie Girouard, Austin, TX (US); Emily Jane Ratliff, Austin, TX (US)

Correspondence Address: IBM CORP (AP);C/O AMY PATTILLO, P. O. BOX 161327, AUSTIN, TX, 78716, US

(73) Assignee: International Business Machines Corporation, Armonk, NY (US)

(21) Appl. No.: 10/682,421

(22) Filed: Oct. 9, 2003

(51) Int. Cl. G06F 11/30; G06F 12/14

(52) U.S. Cl. 713/200

(57) ABSTRACT

A method, system, and program for mitigating self-propagating e-mail viruses are provided. A request to send an electronic mail message with a file attachment to intended recipients is received. A characteristic of the intended recipients are compared with a maximum recipient limit for the file attachment. If the characteristic of the intended recipients exceeds the maximum recipient limit for the file attachment, then a sender authorization is requested prior to sending the electronic mail message. The sender authorization is required such that if a virus is attempting to self-propagate by sending the electronic mail message, the attempt is mitigated.

### BACKGROUND OF THE INVENTION

1. Technical Field

The present invention relates in general to improved electronic mail systems and in particular to mitigating self-propagating electronic mail viruses. Still more particularly, the present invention relates to mitigating self-propagating electronic mail viruses by requiring a sender to provide additional authorization for sending an electronic mail containing a file attachment if the number of intended recipients exceeds a maximum limit of recipients for an electronic mail with file attachment.

2. Description of the Related Art

A “computer virus” is a program designed to infiltrate computer files and other sensitive areas on a computer. Often, the purpose of a virus is to compromise the computer's security. For example, a virus may erase or damage data stored on the computer or stored on network file servers accessible to the computer. In another example, a virus may obtain and forward sensitive information without the computer user's permission.

Viruses are often spread when computer users send infected files to other computer users via electronic mail (e-mail), however viruses may also spread when infected files are copied from one computer to another via a network. Some e-mail viruses are capable of spreading from computer to computer with little or no intervention on the part of the computer user. These viruses are designed to self-propagate by creating an e-mail message from the infected party that is then sent to each e-mail address within the infected party's address book. Within the network implemented by a particular business, it is common that the e-mail address book for each employee contain e-mail addresses for all other employees. A self-propagating e-mail virus can spread rapidly and broadly if it reaches one employee within such a system. Another capability of a self-propagating e-mail virus is to attach or embed a file from the infected system, destroying the security of the files stored on the system by unauthorized distributions. Further, the e-mail virus often attaches itself to a file and infects the computer on which the file is opened.

The standard approach to protecting against computer viruses is to detect their presence on a computer or network using a virus scanner. Virus scanners provide some protection, however, most virus scanners require constant updates and virus scanners may not catch a new virus before the update is available. Thus, it is advantageous to create multiple layers of security in addition to a virus scanner that looks for known viruses.

Within the multiple layers of security, there is a need to find ways to disrupt the spread of self-propagating e-mail viruses. Since self-propagating e-mail viruses often send an infected e-mail to more than one recipient, there is a need to disrupt the propagation by detecting when more than a maximum number of recipients are selected to receive an e-mail. In particular, since such self-propagating e-mail viruses often embed themselves within an attachment or attach a file that is not intended for distribution, there is a need to specify a maximum number of recipients for an e-mail containing an attachment or a copy of a file from a sender. Therefore, it would be advantageous to provide a method, system, and program for scanning e-mails before they are sent and requiring an additional sender authorization if the e-mail with file attached is addresses to more recipients than a set limit of addresses per e-mail with file attached.

### SUMMARY OF THE INVENTION

In view of the foregoing, it is therefore an object of the present invention to provide improved e-mail systems.

It is another object of the present invention to provide a method, system and program for mitigating the propagation of e-mail viruses.

It is yet another object of the present invention to provide a method, system and program for mitigating the propagation of e-mail viruses by requiring a sender to provide additional authorization for sending an e-mail containing a file attachment if the number of intended recipients exceeds a maximum limit of recipients for a file attached e-mail.

According to one aspect of the present invention, a request to send an electronic mail message with a file attachment to intended recipients is received. A characteristic of the intended recipients is compared with a maximum recipient limit for the file attachment. If the characteristic for the intended recipients exceeds the maximum recipient limit for the file attachment, then a sender authorization is requested prior to sending the electronic mail message. The sender authorization is required such that if a virus is attempting to self-propagate by sending the electronic mail message, the attempt is mitigated.

Additionally, characteristic of the intended recipients are compared with a maximum recipient limit for a single electronic mail message. Then, if the characteristic of the intended recipients exceed the maximum recipient limit for a single electronic mail message, a sender authorization is also requested prior to sending the electronic mail message.

The maximum recipient limits may be specified per file or may be specified for all files. Maximum recipient limits may be specified by a percentage of the addresses within the address book or a percentage of the addresses within a particular category of the address book. In addition, maximum recipient limits may be a fixed numerical limit. The maximum recipient limits may be based on the total number of intended recipients, a selection of the intended recipients, or those intended recipients also included in the address book. The characteristic of the intended recipients is determined based on the type of values specified by the maximum recipient limits.

According to one aspect of the present invention, the sender authorization is a request for the sender to enter a password authorizing the electronic mail message to be sent. Alternatively, the sender authorization is a request for the sender to enter some type of manual input authorizing the electronic mail message to be sent.

According to another aspect of the present invention, if a sender does not authorize the electronic mail message to be sent, the electronic mail message is blocked. Additionally, an alert is preferably sent to the network administrator or other system monitoring when a sender blocks an electronic mail message from being sent.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a computer system in which the present method, system, and program may be implemented;

FIG. 2 is a block diagram depicting a distributed network system in accordance with the method, system, and program of the present invention;

FIG. 3 is a block diagram depicting an e-mail client in accordance with the method, system, and program of the present invention;

FIG. 4 is a block diagram depicting an address book in accordance with the method, system, and program of the present invention;

FIG. 5 is a block diagram depicting mitigation settings in accordance with the method, system, and program of the present invention;

FIG. 6 is a pictorial illustration of an e-mail with a file attachment to which the present invention is applicable;

FIG. 7 is a pictorial illustration of an e-mail to which the present invention is applicable;

FIG. 8 is a pictorial illustration of an authorization window in accordance with the method, system, and program of the present invention; and

FIG. 9 is a high level logic flowchart of a process and program for mitigating e-mail virus transmissions in accordance with the method, system, and program of the present invention.

### DETAILED DESCRIPTION OF THE PREFERRED EMBODIMENT

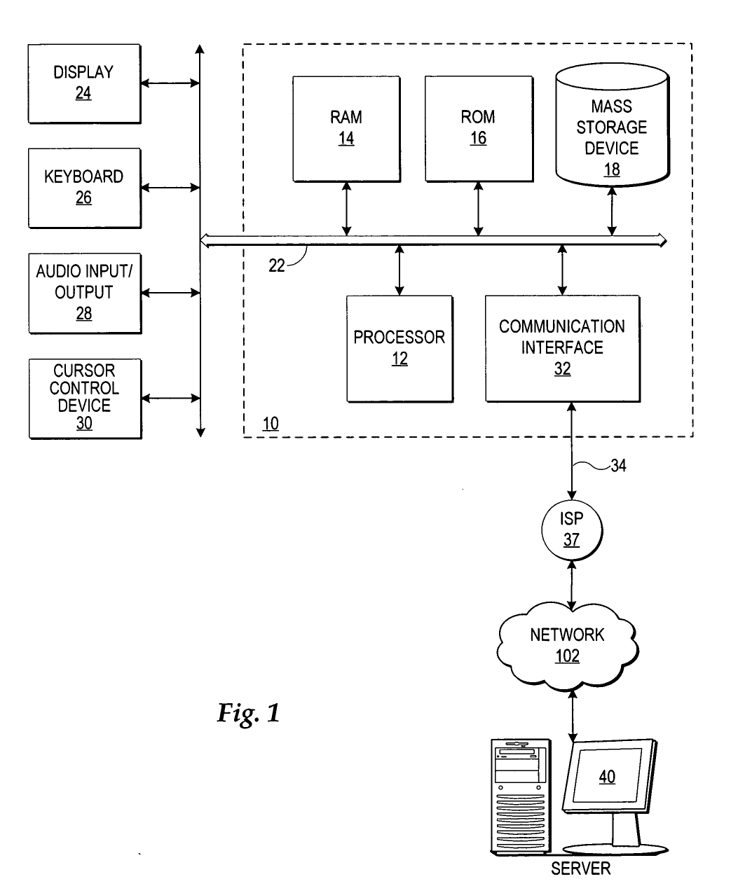

Referring now to the drawings and in particular to FIG. 1, there is depicted one embodiment of a computer system in which the present method, system, and program may be implemented. The present invention may be executed in a variety of systems, including a variety of computing systems and electronic devices under a number of different operating systems. In general, the present invention is executed in a computer system that performs computing tasks such as manipulating data in storage that is accessible to the computer system. In addition, the computer system includes at least one output device and at least one input device.

In one embodiment, computer system 10 includes a bus 22 or other communication device for communicating information within computer system 10, and at least one processing device such as processor 12, coupled to bus 22 for processing information. Bus 22 preferably includes low-latency and higher latency paths that are connected by bridges and adapters and controlled within computer system 10 by multiple bus controllers. When implemented as a server system, computer system 10 typically includes multiple processors designed to improve network servicing power.

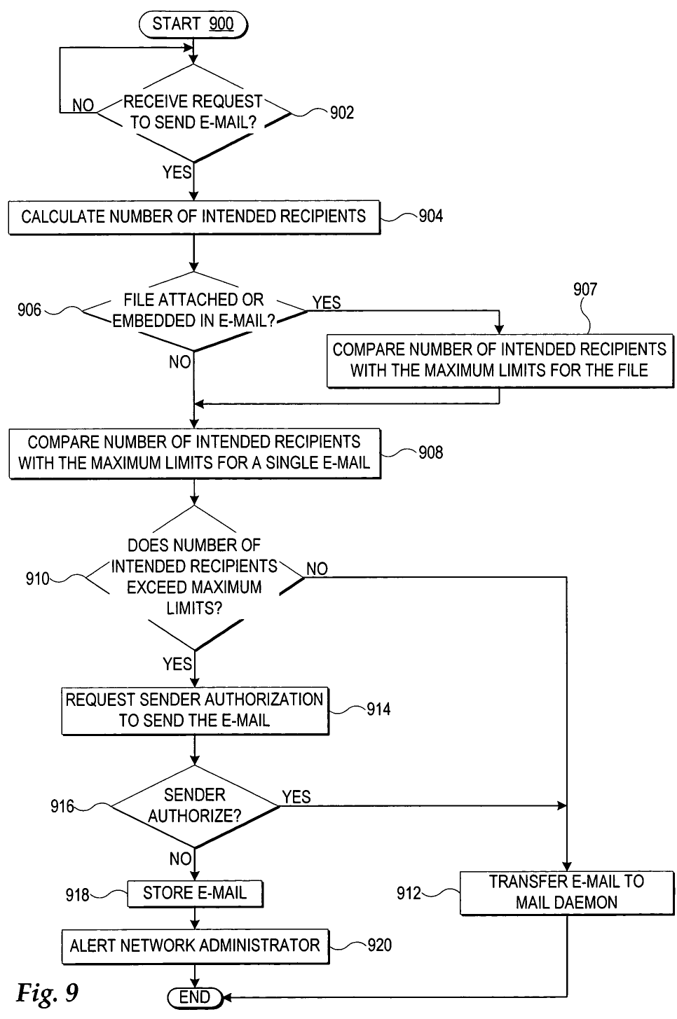

Processor 12 may be a general-purpose processor such as IBM's PowerPC™ processor that, during normal operation, processes data under the control of operating system and application software accessible from a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowchart of FIG. 9, and others described herein. Alternatively, the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of a non-volatile medium is mass storage device 18 which as depicted is an internal component of computer system 10, but will be understood to also be provided by an external device. Volatile media include dynamic memory such as RAM 14. Transmission media include coaxial cables, copper wire or fiber optics, including the wires that comprise bus 22. Transmission media can also take the form of acoustic or light waves, such as those generated during radio frequency or infrared data communications.

Moreover, the present invention may be downloaded as a computer program product, wherein the program instructions may be transferred from a remote computer such as a server 40 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through network 102.

Network 102 may refer to the worldwide collection of networks and gateways that use a particular protocol, such as Transmission Control Protocol (TCP) and Internet Protocol (IP), to communicate with one another. ISP 37 and network 102 both use electrical, electromagnetic, or optical signals that carry digital data streams. The signals through the various networks and the signals on network link 34 and through communication interface 32, which carry the digital data to and from computer system 10, are exemplary forms of carrier waves transporting the information.

When implemented as a server system, computer system 10 typically includes multiple communication interfaces accessible via multiple peripheral component interconnect (PCI) bus bridges connected to an input/output controller. In this manner, computer system 10 allows connections to multiple network computers.

Further, multiple peripheral components may be added to computer system 10, connected to multiple controllers, adapters, and expansion slots coupled to one of the multiple levels of bus 22. For example, an audio input/output 28 is connectively enabled on bus 22 for controlling audio input through a microphone or other sound or lip motion capturing device and for controlling audio output through a speaker or other audio projection device. A display 24 is also connectively enabled on bus 22 for providing visual, tactile or other graphical representation formats. A keyboard 26 and cursor control device 30, such as a mouse, trackball, or cursor direction keys, are connectively enabled on bus 22 as interfaces for user inputs to computer system 10. In alternate embodiments of the present invention, additional input and output peripheral components may be added.

Those of ordinary skill in the art will appreciate that the hardware depicted in FIG. 1 may vary depending on the implementation. Furthermore, those of ordinary skill in the art will appreciate that the depicted example is not meant to imply architectural limitations with respect to the present invention. For example, computer system 10 may take the form of a personal digital assistant device (PDA), a web appliance, a kiosk, or a telephone.

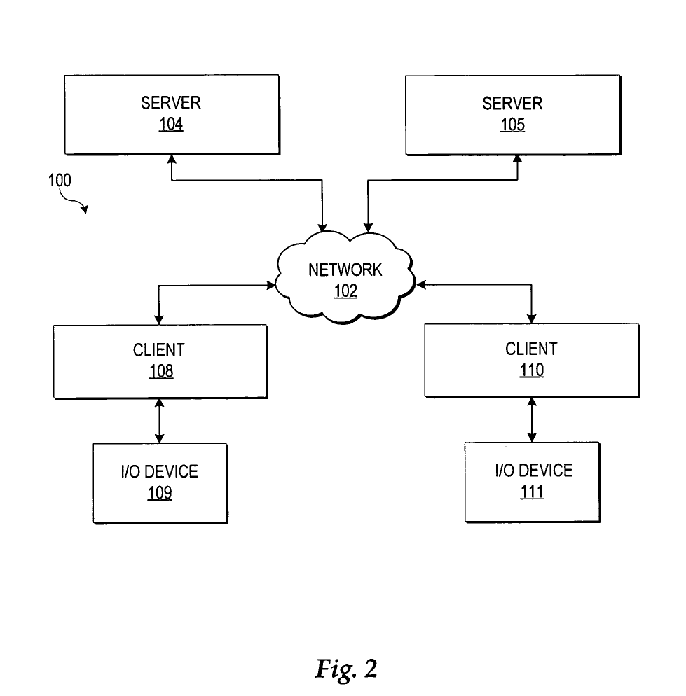

With reference now to FIG. 2, a block diagram depicts a distributed network system in accordance with the method, system, and program of the present invention. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections such as wire or fiber optics cables, temporary connections made through telephone connections and wireless transmission connections.

In the depicted example, servers 104 and 105 are connected to network 102. In addition, clients 108 and 110 are connected to network 102 and provide a user interface through input/output (I/O) devices 109 and 111. Clients 108 and 110 may be, for example, personal computers or network computers. For purposes of this application, a network computer is any computer coupled to a network, which receives a program or other application from another computer coupled to the network.

The client/server environment of distributed data processing system 100 is implemented within many network architectures. For example, the architecture of the World Wide Web (the Web) follows a traditional client/server model environment. The terms “client” and “server” are used to refer to a computer's general role as a requester of data (the client) or provider of data (the server). In the Web environment, web browsers such as Netscape Navigator™ typically reside on client systems 108 and 110 and render Web documents (pages) served by a web server, such as servers 104 and 105. Additionally, each of client systems 108 and 110 and servers 104 and 105 may function as both a “client” and a “server” and may be implemented utilizing a computer system such as computer system 10 of FIG. 1. Further, while the present invention is described with emphasis upon servers 104 and 105 enabling downloads or communications, the present invention may also be performed by client systems 108 and 110 engaged in peer-to-peer network communications and downloading via network 102.

The Web may refer to the total set of interlinked hypertext documents residing on servers all around the world. Network 102, such as the Internet, provides an infrastructure for transmitting these hypertext documents between client systems 108 and 110 and servers 104 and 105. Documents (pages) on the Web may be written in multiple languages, such as Hypertext Markup Language (HTML) or Extensible Markup Language (XML), and identified by Uniform Resource Locators (URLs) that specify the particular web page server from among servers, such as server 104 and pathname by which a file can be accessed, and then transmitted from the particular web page server to an end user utilizing a protocol such as Hypertext Transfer Protocol (HTTP) or file-transfer protocol (FTP). Web pages may further include text, graphic images, movie files, and sounds, as well as Java applets and other small embedded software programs that execute when the user activates them by clicking on a link. In particular, multiple web pages may be linked together to form a web site. The web site is typically accessed through an organizational front web page that provides a directory to searching the rest of the web pages connected to the web site. While network 102 is described with reference to the Internet, network 102 may also operate within an intranet or other available networks.

Additionally, servers 104 and 105 may serve as communication hosts for transferring communications between clients 108 and 110. For example, servers 104 and 105 may serve as communication hosts for e-mail communication between clients 108 and 110. For example, client 108 may send a message intended for a recipient using client 110. Server 104 functions as an e-mail server for client 110 and stores the e-mail until client 110 requests the e-mail originating from client 108. For purposes of illustration, the examples following are implemented using e-mail communications, however, other types communications may be used to implement the present invention including, but not limited to, instant messaging, text messaging, chatting, video conferencing and any other form of communication made available via network 102.

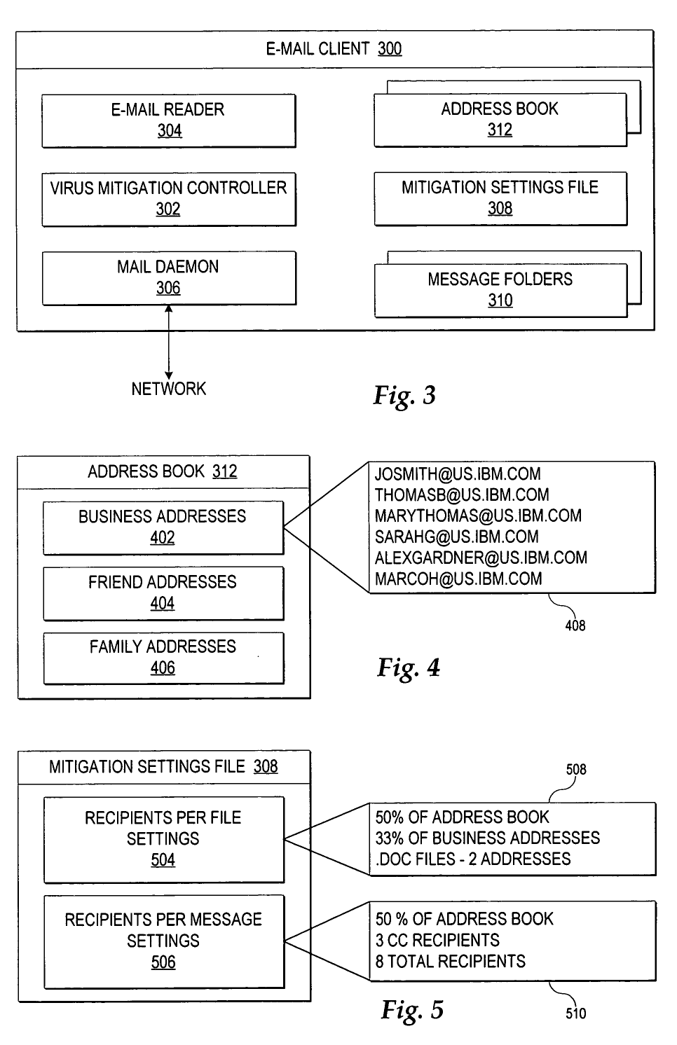

With reference now to FIG. 3, there is depicted a block diagram of an e-mail client in accordance with the method, system, and program of the present invention. As illustrated, an e-mail client 300 includes an e-mail reader 304 and mail daemon 306.

E-mail reader 304 also allows a user to compose, file, search and read e-mail. Mail daemon 306 receives e-mail intended for the user of e-mail client 300 and stores the e-mail in message folders 310. A virus attached to a received e-mail stored in message folders 310 may attempt to compose an e-mail through e-mail reader 304, while posing as the user. The virus selects addresses for intended recipients of the virus-composed e-mail from an address book 312. Address book 312 is typically a database for storing e-mail addresses and contact information.

E-mail reader 304 gives mail daemon 306 messages to send to specified intended recipients. Mail daemon 306 uses simple mail transfer protocol (SMTP) running over TCP via the network to transmit the message to a mail daemon running on another machine, typically the mail server, that puts the message into a mailbox where it is retrievable by the intended recipient.

It is an advantageous to scan an e-mail before the e-mail is sent by mail daemon 306 to stop the transmission of an e-mail containing a virus. In order to reduce transmission of viruses, it is advantageous to apply multiple layers of security. One of these layers of security is implemented through virus mitigation controller 302 included in e-mail client 300.

Virus mitigation controller 302 scans each e-mail to be sent before the e-mail is given to mail daemon 306. Virus mitigation controller 302 first determines the number of intended recipient addresses in the e-mail and other characteristics of the intended recipients. Next, virus mitigation controller 302 determines whether there is a file attachment or a file embedded in the e-mail. Thereafter, virus mitigation controller 302 will compare the number of intended recipient addresses and other characteristics with multiple mitigation settings stored in memory as mitigation settings file 308. If, for example, the number of intended recipient addresses in the e-mail exceeds the mitigation settings for the type of e-mail, then the e-mail is not passed to mail daemon 306 unless the user authorizes the e-mail to be sent. A blocked e-mail is stored in message folder 310 and an alert is initiated by virus mitigation controller 302 to a network administrator or other service that monitors potential viruses.

In one embodiment of the present invention, the components described within e-mail client 300 are accessible within a single computer system. However, in alternate embodiments of the present invention, the components described within e-mail client 300 are accessible via multiple computer systems across a distributed network system.

Referring now to FIG. 4, there is illustrated a block diagram of the elements of an address book in accordance with the method, system, and program of the present invention. As depicted, address book 312 of e-mail client 300 in FIG. 3 provides a database of stored e-mail addresses and other addressing information. For purposes of illustration, address book 312 sorts e-mail address in three groups: business addresses 402, friend addresses 404 and family addresses 406. It will be understood that any type of database structure may be utilized by address book 312 to sort and store e-mail addresses. For purposes of example, a selection of the e-mail addresses stored in business addresses 402 are depicted at reference numeral 408.

With reference now to FIG. 5, there is depicted a block diagram of the mitigation settings file in accordance with the method, system, and program of the present invention. As illustrated, mitigation settings file 308 of e-mail client 300 in FIG. 3 provides a database of stored mitigating settings. In one embodiment, mitigation settings file 308 includes two types of settings: recipients per file settings 504 and recipients per message settings 506. In alternate embodiments, other types of settings may be implemented. Further, in addition to user specified settings, default settings may be included in mitigation settings file 308.

For purposes of example, a selection of user designated settings stored as recipients per file settings 504 is depicted at reference numeral 508. Recipients per file settings 504 includes settings associated with an e-mail to which a file is attached or within which a file is embedded. In the selection depicted at reference numeral 508, three examples of settings are illustrated. The first two examples are maximum limits set based on percentages. First, a maximum of 40% of the addresses in the address book is set. Second, a maximum of 33% of the business addresses in the address book is set. Additionally, a limit is set by the type of file. For example, for .doc files, a maximum of four addresses is set. In alternate embodiments of the present invention, other values may be set as maximum limits for all e-mails containing files.

In addition, for purposes of example, a selection of user designated settings stored as recipients per message settings is depicted at reference numeral 510. Recipients per message settings 506 includes settings associated with all e-mails. In the selection depicted at reference numeral 510, three examples of settings are illustrated. First, a maximum limit is set based on a percentage of the addresses within the address book. Second, a maximum number of recipients that are carbon copy (cc) recipients is set. Third, a maximum number of total recipients is set. In alternate embodiments of the present invention, other values may be set as maximum limits for all e-mails.

The values set in mitigation settings file 308 may be set by the user or set remotely by a network administrator or virus detection service. Additionally, virus mitigation controller 302 may monitor the typical use of a particular user and set mitigation settings file 308 according to that use.

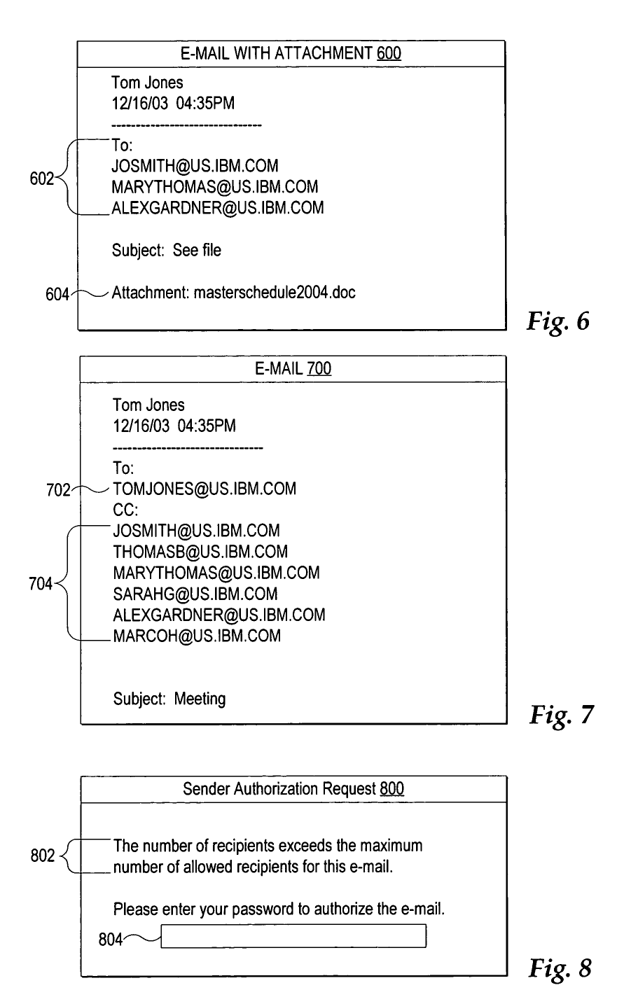

Referring now to FIG. 6, there is depicted a pictorial illustration of an e-mail with a file attachment to which the present invention is applicable. As illustrated in the example, an e-mail with attachment 600 is composed by Tom Jones to be sent to the e-mail addresses indicated at reference numeral 602. In the example, when comparing the e-mail addresses indicated at reference numeral 602 with the business e-mail addresses indicated by reference numeral 408 in FIG. 4, it is apparent that every other e-mail address is included as intended addressees of e-mail with attachment 600. E-mail with attachment 600 depicts an example of a behavior a virus may exhibit by selecting some, but not all of the addresses in an address book. Additionally, e-mail with attachment 600 illustrates an example of a behavior a virus may exhibit by attaching a file as indicated at reference numeral 604. Although not depicted, as an alternative to attaching the file, a virus may embed the file within e-mail with attachment 600.

In response to a user request to send e-mail with attachment 600, the virus mitigation controller preferably scans e-mail with attachment 600 to determine if any of the maximum addressing limits are exceeded. First, the virus mitigation controller counts the number of intended e-mail addresses and other characteristics in the composed e-mail with attachment 600. Additionally, the virus mitigation controller may compare the intended e-mail addresses with the business addresses in the address book to determine the number of business addresses included in e-mail 600. Next, the virus mitigation controller compares the number of intended e-mail addresses and other characteristics of the intended e-mail addresses with the maximum addressing settings. According to the limits set as indicated at reference numeral 508 of FIG. 5, the number of intended e-mail addresses exceeds the maximum number of addresses (2) for a .doc file which is attached, as indicated at reference numeral 604. Additionally, according to the limits set as indicated at reference numeral 508 of FIG. 5, the number of intended e-mail addresses exceeds the maximum percentage (33%) of the business addresses. Although in the present example the number of intended addresses in e-mail with attachment 600 does not exceed the limits set per message as indicated at reference numeral 510 of FIG. 5, in alternate embodiments, e-mail messages with file attachments may exceed both file based and per message based of limits.

With reference now to FIG. 7, there is depicted a pictorial illustration of an e-mail to which the present invention is applicable. As depicted in the example, an e-mail 700 is composed by Tom Jones to be sent to the e-mail addresses indicated at reference numerals 702 and 704. In the example, when comparing the e-mail addresses indicated at reference numerals 702 and 704 with the business e-mail addresses indicated at reference numeral 408 of FIG. 4, it is apparent that all the business e-mail addresses are included as intended addresses of e-mail 700. E-mail 700 illustrates an example of a behavior a virus may exhibit by sending the e-mail primarily to the sender and then carbon copying the rest of the addresses in the address book. Here, e-mail 700 is sent primarily to the sender, Tom Jones, as indicated at reference numeral 702 and carbon copied to all the business e-mail address.

In response to a user request to send e-mail 700, the virus mitigation controller preferably scans e-mail 700 to determine if any of the maximum addressing limits are exceeded. First, the virus mitigation controller counts the number of intended e-mail addresses in the composed e-mail 700. In the example, the characteristics of the intended e-mail addresses include a total count of each of the intended e-mail addresses and a total count of the number of carbon copied e-mail addresses. Next, the virus mitigation controller compares the number of intended e-mail addresses with the maximum address settings. According to the limits set as indicated at reference numeral 510 of FIG. 5, the number of cc recipients within intended e-mail addresses exceeds the maximum number of cc recipients (5) indicated at reference numeral 604.

Referring now to FIG. 8, there is depicted a pictorial illustration of an authorization window in accordance with the method, system, and program of the present invention. A sender authorization request window 800 or other form of sender authorization request is initiated when the virus mitigation controller determines that the maximum addressing limits are exceeded for an e-mail before it is sent. For example, in response to a request to send the e-mails depicted in FIGS. 6 and 7, an authorization request will be initiated.

The additional step of requesting a sender to provide authorization through an additional manual or verbal input before sending the e-mail will aid in mitigating the propagation of e-mail viruses. As an example of such a request, a sender is prompted with a message indicating that the maximum limit is exceeded as indicated at reference numeral 802. The sender is then prompted to enter a password at entry block 804 to authorize the e-mail. In an alternate embodiment, the sender may only be required to select a button or provide other entry. Further, in an alternate embodiment, the message output to the sender may indicate the specific maximum limit exceeded. Furthermore, in an alternate embodiment a separate request may be made for each limit exceeded.

With reference now to FIG. 9, there is illustrated a high level logic flowchart of a process and program for mitigating e-mail virus transmissions in accordance with the method, system, and program of the present invention. As depicted, the process starts at block 900 and thereafter proceeds to block 902. Block 902 illustrates a determination as to whether a request to send an e-mail is received. The process iterates at block 902 until a request to send an e-mail is received, and then the process passes to block 904. Block 904 depicts calculating the number of intended recipients. In particular, multiple characteristics of the intended recipients may be calculated, including but not limited to, all intended recipients, all primary intended recipients, all carbon copied intended recipients, all recipient addresses to a particular mail provider, and other categories necessary to calculate for determining whether a maximum limit is exceeded. In addition, if a maximum limit is based on the number of intended recipients whose addresses are also in the address book, then a comparison of the intended recipients and address book will also be required to determine the characteristics of the intended recipients.

Next, block 906 depicts a determination as to whether a file is attached or embedded in the e-mail. If a file is attached or embedded in the e-mail, then the process passes to block 907. In particular, if a file is embedded in an e-mail or copied into an e-mail a flag is preferably set which is later detected at the step in the process depicted by block 906. Block 907 illustrates comparing the number of intended recipients with the maximum limits for the file, and the process passes to block 908.

Returning to block 906, if a file is not attached or embedded in the e-mail, then the process passes to block 908. Block 908 illustrates comparing the number of intended recipients with the maximum limits for a single e-mail. Thereafter, block 910 depicts a determination as to whether the number of intended recipients exceeds the maximum limits. If the number of intended recipients does not exceed the maximum limits, then the e-mail as transferred to the mail daemon as illustrated at block 912, and the process ends. However, if the number of intended recipients exceeds the maximum parameters, then the process passes to block 914.

Block 914 depicts requesting a sender authorization to send the e-mail. This authorization may require the sender to enter a password or to just enter authorize the sending by a manual input such as a mouse click or a keystroke. Preferably, an input is required that is not easily fabricated by a virus. Next, block 916 illustrates a determination whether the sender authorized sending the e-mail. If the sender authorizes sending the e-mail, then the process passes to block 912. If the sender does not authorize sending the e-mail, then the process passes to block 918. Block 918 depicts storing the e-mail. Thereafter, block 920 illustrates alerting the network administrator that an e-mail has been blocked, and the process ends.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular types of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

While the invention has been particularly shown and described with reference to a preferred embodiment, it will be understood by those skilled in the art that various changes in form and detail may be made therein without departing from the spirit and scope of the invention.

1. A method for mitigating self-propagating electronic mail viruses, comprising:
receiving a request to send an electronic mail message with a file attachment to at least one intended recipient;
comparing a characteristic of said at least one intended recipient with a maximum recipient limit for said file attachment; and
responsive to said characteristic of said at least one intended recipient exceeding said maximum recipient limit for said file attachment, requesting a sender authorization prior to sending said electronic mail message, such that if a virus is attempting to self-propagate by sending said electronic mail message said attempt is mitigated.

2. The method according to claim 1 for mitigating self-propagating electronic mail viruses, further comprising:
comparing said characteristic of said at least one intended recipient with a maximum recipient limit for said electronic mail message; and
responsive to said characteristic of said at least one intended recipient exceeding said maximum number of recipients for said electronic mail message, requesting a sender authorization prior to sending said electronic mail message.

3. The method according to claim 1 for mitigating self-propagating electronic mail viruses, wherein receiving a request to send an electronic mail message with a file attachment further comprises:
detecting a file embedded within said electronic mail message as a file attachment.

4. The method according to claim 1 for mitigating self-propagating electronic mail viruses, wherein comparing said characteristic of said at least one intended recipient with a maximum recipient limit further comprises:
comparing at least one address for said at least one intended recipient with an address book of recipients;
calculating a number of said at least one address of said at least one intended recipient matching addresses within said address book of recipients; and
determining whether a number of said matching addresses exceeds a maximum limit of addresses within said address book of recipients.

5. The method according to claim 1 for mitigating self-propagating electronic mail viruses, wherein comparing said characteristic of said at least one intended recipient with a maximum recipient limit further comprises:
comparing a number of said at least one intended recipient with a maximum recipient limit for a type of said file attachment.

6. The method according to claim 1 for mitigating self-propagating electronic mail viruses, wherein requesting a sender authorization prior to sending said electronic mail message further comprises:
requesting at least one of an entry of a password as authorization and a manual sender input.

7. The method according to claim 1 for mitigating self-propagating electronic mail viruses, further comprising:
receiving said maximum recipient limit from at least one of a network administrator and a user.

8. The method according to claim 1 for mitigating self-propagating electronic mail viruses, further comprising:
responsive to receiving a denial of said sender authorization, alerting a network administrator that said electronic mail message was blocked.

9. A system for mitigating self-propagating electronic mail viruses, comprising:
a computing system communicatively connected to a network;
said computing system further comprising:
means for receiving a request to send an electronic mail message with a file attachment to at least one intended recipient;
means for comparing a characteristic of said at least one intended recipient with a maximum recipient limit for said file attachment; and
means for requesting a sender authorization prior to sending said electronic mail message, responsive to said characteristic of said at least one intended recipient exceeding said maximum recipient limit for said file attachment.

10. The system according to claim 9 for mitigating self-propagating electronic mail viruses, said computing system further comprising:
means for comparing said characteristic of said at least one intended recipient with a maximum recipient limit for said electronic mail message; and
means for requesting a sender authorization prior to sending said electronic mail message, responsive to said characteristic of said at least one intended recipient exceeding said maximum number of recipients for said electronic mail message.

11. The system according to claim 9 for mitigating self-propagating electronic mail viruses, wherein said means for receiving a request to send an electronic mail message with a file attachment further comprises:
means for detecting a file embedded within said electronic mail message as a file attachment.

12. The system according to claim 9 for mitigating self-propagating electronic mail viruses, wherein said means for comparing said characteristic of said at least one intended recipient with a maximum recipient limit further comprises:
means for comparing at least one address for said at least one intended recipient with an address book of recipients;
means for calculating a number of said at least one address of said at least one intended recipient matching addresses within said address book of recipients; and
means for determining whether a number of said matching addresses exceeds a maximum limit of addresses within said address book of recipients.

13. The system according to claim 9 for mitigating self-propagating electronic mail viruses, wherein said means for comparing said characteristic of said at least one intended recipient with a maximum recipient limit further comprises:
means for comparing a number of said at least one intended recipient with a maximum recipient limit for a type of said file attachment.

14. The system according to claim 9 for mitigating self-propagating electronic mail viruses, wherein said means for requesting a sender authorization prior to sending said electronic mail message further comprises:
means for requesting at least one of an entry of a password as authorization and a manual sender input.

15. The system according to claim 9 for mitigating self-propagating electronic mail viruses, further comprising:
means for receiving said maximum recipient limit from at least one of a network administrator and a user.

16. The system according to claim 9 for mitigating self-propagating electronic mail viruses, further comprising:
means responsive to receiving a denial of said sender authorization, for alerting a network administrator that said electronic mail message was blocked.

17. A computer program product for mitigating self-propagating electronic mail viruses, comprising:
a recording medium;
means, recorded on said recording medium, for receiving a request to send an electronic mail message with a file attachment to at least one intended recipient;
means, recorded on said recording medium, for comparing a characteristic of said at least one intended recipient with a maximum recipient limit for said file attachment; and
means, recorded on said recording medium, for requesting a sender authorization prior to sending said electronic mail message, responsive to said characteristic of said at least one intended recipient exceeding said maximum recipient limit for said file attachment.

18. The computer program product according to claim 17 for mitigating self-propagating electronic mail viruses, further comprising:
means, recorded on said recording medium, for comparing said characteristic of said at least one intended recipient with a maximum recipient limit for said electronic mail message; and
means, recorded on said recording medium, for requesting a sender authorization prior to sending said electronic mail message, responsive to said characteristic of said at least one intended recipient exceeding said maximum number of recipients for said electronic mail message.

19. The computer program product according to claim 17 for mitigating self-propagating electronic mail viruses, wherein said means for receiving a request to send an electronic mail message with a file attachment further comprises:
means, recorded on said recording medium, for detecting a file embedded within said electronic mail message as a file attachment.

20. The computer program product according to claim 17 for mitigating self-propagating electronic mail viruses, wherein said means for comparing said characteristic of said at least one intended recipient with a maximum recipient limit further comprises:
means, recorded on said recording medium, for comparing at least one address for said at least one intended recipient with an address book of recipients;
means, recorded on said recording medium, for calculating a number of said at least one address of said at least one intended recipient matching addresses within said address book of recipients; and
means, recorded on said recording medium, for determining whether a number of said matching addresses exceeds a maximum limit of addresses within said address book of recipients.

21. The computer program product according to claim 17 for mitigating self-propagating electronic mail viruses, wherein said means for comparing said at least one intended recipient with a maximum recipient limit further comprises:
means, recorded on said recording medium, for comparing said at least one intended recipient with a maximum recipient limit for a type of said file attachment.

22. The computer program product according to claim 17 for mitigating self-propagating electronic mail viruses, wherein said means for requesting a sender authorization prior to sending said electronic mail message further comprises:
means, recorded on said recording medium, for requesting at least one of an entry of a password as authorization and a manual sender input.

23. The computer program product according to claim 17 for mitigating self-propagating electronic mail viruses, further comprising:
means, recorded on said recording medium, for receiving said maximum recipient limit from at least one of a network administrator and a user.

24. The computer program product according to claim 17 for mitigating self-propagating electronic mail viruses, further comprising:
means, recorded on said recording medium, for alerting a network administrator that said electronic mail message was blocked, responsive to receiving a denial of said sender authorization.
